(19) United States
(12) Patent Application Publication
(10) Pub. No.: US 2005/0281021 A1
(43) Pub. Date: Dec. 22, 2005

(54) Flashlight assembly and a method of using the same

(76) Inventor: Harvey J. Thompson, Oceanside, CA (US)

Correspondence Address: GORDON & RAES LLP, 101 WEST BROADWAY, SUITE 1600, SAN DIEGO, CA, 92101, US

(21) Appl. No.: 10/873,981

(22) Filed: Jun. 21, 2004

(51) Int. Cl. F21L 7/00

(52) U.S. Cl. 362/157

(57) ABSTRACT

A flashlight assembly and a method of using the flashlight assembly is disclosed. The flashlight assembly is easily stored when not in use. The flashlight assembly and the method for using the flashlight are herein disclosed wherein the flashlight is a compact light assembly having a battery contained thereon. The flashlight assembly includes a retractable spring biased wire assembly. The wiring may be retracted into a storage housing when the light assembly is not in use. The present invention uses a retractable wire to manipulate and secure the light assembly when the light assembly is not in use. Moreover, the flashlight assembly provides for a flashlight assembly that is easily stored on a user and is space efficient.

### TECHNICAL BACKGROUND

The present invention generally relates to a product that provides light. More specifically, the present invention relates to a flashlight system that may be compact yet highly useful. Further, the present invention relates to a flashlight that may be stored in a compartment and extended away from the compartment for use. Moreover, the present invention may be clipped to an article and use an extension to illuminate something away from said article.

### BACKGROUND OF THE INVENTION

It has been taught in the prior art certain retraction units which are widely used today for retaining and retracting different mechanical devices. These prior art examples include wenches, retractable key rings, access cards and the like. Many of the devices related to a key reel. Conventional key reels have a reel and spring carried in a housing, with a chain or cable on the reel. A fitting is carried on the outer end of the chain or cable for attaching a key or a key ring or access card or other object as desired to the end of the chain and/or cable.

Traditional flashlights are used for a variety of different purposes by a wide variety of different users. The uses for flashlights can range from household uses, commercial uses, and even military use. Typically, the flashlight is handheld and usually large in size. The benefits of having a flashlight is that they can be used to direct light onto a desired object. The flashlight can be directed to where it is needed without the need to manipulate the light or to move it from a fixed position. Moreover, flashlights are portable in nature and can be moved from location to location. Further still, beyond being portable, most flashlights are battery powered such that they may be used when necessary and stored for periods of time.

However, limitations exist when it comes to the size and efficiency of the flashlights. Unfortunately, most flashlights are rather large in size and can be cumbersome to carry. Because the battery must be contained within the flashlight, it is very difficult to make the flashlight of small, compact design without affecting the power and intensity of the light apparatus. Moreover, most flashlights are hand held and therefore occupy one of the hands of the user, making it difficult for the user to perform certain tasks when operating the flashlight. Moreover, as flashlight sizes are typically large because of the need for battery space, the flashlight is not easily carried on the person of the user when not in use, and does not fit easily into pre-constructed storage spaces. Further still, when a user has finished using a flashlight, they must either hold on to the unit or find suitable storage for the flashlight to free up their hands for other purposes.

A need, therefore, exists for an improved flashlight that is compact and efficient in size. More specifically, a need exists for a flashlight that is small, battery operated and that may have a retractable wire that may be housed in a storage receptacle.

Further, a need therefore exists for an improved flashlight that may have a small light having a retractable wire that may be housed in a storage receptacle that may be positioned on a person, and/or object and may allow the individual to store the light when not in use easily, and without great effort to find storage space for the unit. Moreover, an improvement is needed for a compact flashlight that can be manipulated for use quickly and easily when needed by a user.

### SUMMARY OF THE INVENTION

The present invention provides a flashlight assembly and a method of using the same that may be easily stored when not in use. More specifically, the present invention relates to a product and a method for using a flashlight wherein the flashlight is a compact light assembly having a battery contained thereon wherein the light assembly is connected to a retractable wiring. The wiring may be retracted into a storage housing when the light assembly is not in use. The present invention uses a retractable wire to manipulate and secure the light assembly when the light assembly is not in use. Moreover, the present invention provides for a flashlight assembly that is easily stored on a user and is space efficient.

To this end, in an embodiment of the present invention, a retractable flashlight assembly for use in conjunction with a lighting assembly is provided. The flashlight assembly may have a lighting assembly that has a light source contained thereon. The flashlight assembly may also include a spring-biased wire assembly mounted within a storage receptacle for extracting and retracting said lighting assembly. Moreover, the flashlight assembly may include a storage receptacle to house the spring-biased wire assembly when wire assembly is retracted wherein a user can extract the lighting assembly from a position adjacent the storage receptacle to illuminate an object and thereafter retract the lighting assembly to a position adjacent the storage receptacle. Further, the flashlight assembly has an attachment means whereby the flashlight assembly is securable about an object.

In an embodiment, a flashlight assembly and a method of using the same is provided wherein said lighting assembly has a light source wherein said light source is a bulb and further wherein said lighting assembly has a button contained thereon to turn on and turn off said light source.

In an embodiment, a flashlight assembly and a method of using the same is provided wherein said lighting assembly has a power source contained thereon to power the light source.

In an embodiment, a flashlight assembly and a method of using the same is provided wherein said light assembly is detachably secured to the wire assembly and further wherein said light source is activated by a light sensor.

In an embodiment, a flashlight assembly and a method of using the same is provided wherein said spring biased wire assembly is detachably secured to the lighting assembly at a first end and being secured to the storage receptacle at a second end.

In an embodiment, a flashlight assembly and a method of using the same is provided wherein the storage receptacle has a means for attaching to an article.

In an embodiment, a flashlight assembly and a method of using the same is provided wherein the flashlight assembly is securable about an object wherein the attachment means has a fastening clip.

In an embodiment, a flashlight assembly and a method of using the same is provided wherein the flashlight assembly is securable about an object wherein the attachment means has loop contained thereon.

In an embodiment, a flashlight assembly and a method of using the same is provided the storage receptacle may be inserted into the attachment means whereby the storage receptacle may be secured to the attachment means wherein the attachment means secures the lighting assembly, storage receptacle and wire assembly to an object.

In an embodiment, a flashlight assembly and a method of using the same is provided wherein the attachment means has a pocket contained thereon to store accessories.

In an embodiment, a flashlight assembly and a method of using the same is provided where the attachment means has an opening contained thereon wherein a wire from said wire assembly may extend outwardly away from said attachment means when said attachment means is secured to an object.

In an embodiment, a flashlight assembly and a method of using the same is provided wherein the attachment means has a fixed opening contained on the bottom thereof and further wherein the attachment means has a resealable opening on the top thereof wherein said resealable opening uses a hook and loop fastener and wherein said resealable opening allows for insertion of said storage receptacles or accessories into said attachment means.

In an embodiment of the present invention, a method for using the flashlight assembly is provided, the method comprising the steps of: providing a lighting assembly having a light source contained thereon; providing a spring-biased wire assembly mounted within a storage receptacle wherein said wire assembly has a first side and a second side wherein said first side is detachably connected to the lighting assembly and further wherein said second side is connected to a storage receptacle; providing a storage receptacle to house the spring-biased wire assembly; and providing an attachment means whereby the flashlight assembly is securable about an object wherein said attachment means may be opened to contain the storage receptacle and further wherein said attachment means has a fixed opening wherein said wire assembly may extend out of said fixed opening.

In an embodiment, a flashlight assembly and a method of using the same includes the step of securing the attachment means to a object wherein the attachment means may use a hook and loop fastener, a clip assembly, a zipper and/or loop to attach to an object.

In an embodiment, a flashlight assembly and a method of using the same includes the step of grasping the lighting assembly from a position adjacent the attachment means and extending said lighting assembly away from said attachment means by use of the wire assembly wherein the wire assembly extends outwardly away from said storage receptacle.

In an embodiment, a flashlight assembly and a method of using the same includes the step of depressing a button contained on the lighting assembly to activate the light source.

In an embodiment, a flashlight assembly and a method of using the same includes the step of moving the lighting assembly to illuminate a desired object wherein the wire allows for maneuverability of the lighting assembly away from the attachment means.

In an embodiment, a flashlight assembly and a method of using the same includes the step of depressing a button on the lighting assembly to de-activate the light source.

In an embodiment, a flashlight assembly and a method of using the same includes the step of allowing the spring biased wire to detract into the storage receptacle wherein the lighting assembly is retracted therewith such that the lighting assembly becomes adjacent to the attachment means.

In an embodiment, a flashlight assembly and a method of using the same includes the step of releasing the lighting assembly and allowing said attachment means to carry said flashlight assembly when not in use.

It is, therefore, an advantage of the present invention to provide a flashlight assembly and a method for using the same.

Another advantage of the present invention is to provide a flashlight assembly and a method for using the same wherein the flashlight has a light assembly.

Still another advantage of the present invention is to provide a flashlight assembly and a method for using the same wherein the flashlight has a light assembly that is compact in nature.

Yet another advantage of the present invention is to provide a flashlight assembly and a method for using the same wherein the flashlight may have a light assembly that is small and lightweight.

Still another advantage of the present invention is to provide a flashlight assembly and a method for using the same wherein the flashlight may have a light assembly that may have a high intensity illumination discharge.

Another advantage of the present invention is to provide a flashlight assembly and a method for using the same wherein the flashlight may have a light assembly that may be manufactured in a plurality of colors.

Yet another advantage of the present invention is to provide a flashlight assembly and a method for using the same wherein the flashlight may have a light assembly wherein a battery is contained within the light assembly.

An advantage of the present invention is to provide a flashlight assembly and a method for using the same wherein the flashlight may have a light assembly wherein the light assembly may have an on/off button thereon.

Another advantage of the present invention is to provide a flashlight assembly and a method for using the same wherein the flashlight may have a light assembly wherein the light assembly may have a button that may activate the light source.

Yet another advantage of the present invention is to provide a flashlight assembly and a method for using the same wherein the flashlight may have a light assembly that may be detactably connected to a wire.

Still another advantage of the present invention is to provide a flashlight assembly and a method for using the same wherein the flashlight assembly may have a light assembly that is fixably attached to a wire.

An advantage of the present invention is to provide a flashlight assembly and a method for using the same wherein the flashlight may have a light source that is attached to a wire.

Yet another advantage of the present invention is to provide a flashlight assembly and a method for using the same wherein the flashlight may have a light source that is attached to a retractable wire structure.

Another advantage of the present invention is to provide a flashlight assembly and a method for using the same wherein the flashlight may have a light source that may be attached to a retractable wire structure wherein the wire structure may be housed in a storage container.

Yet another advantage of the present invention is to provide a flashlight assembly and a method for using the same wherein the flashlight assembly may have a storage container.

Still another advantage of the present invention is to provide a flashlight assembly and a method for using the same wherein the flashlight assembly may have a storage container and wherein the storage container may house a retractable wire.

Another advantage of the present invention is to provide a flashlight assembly and a method for using the same wherein the flashlight assembly may have a storage container that may be adapted to connect to the clothes of a person.

Still another advantage of the present invention is to provide a flashlight assembly and a method for using the same wherein the flashlight assembly may have a storage container that may have a hook and fastener apparatus thereon.

Yet another advantage of the present invention is to provide a flashlight assembly and a method for using the same wherein the flashlight assembly may have a storage container that may have a strap to connect to the clothing of a user.

An advantage of the present invention is to provide a flashlight assembly and a method for using the same wherein the flashlight assembly may have a storage container that may have a strap to connect to the belt of a user.

Another advantage of the present invention is to provide a flashlight assembly and a method for using the same wherein the flashlight assembly may include a storage receptacle that may have another type of attachment device to connect a connection article.

Yet another advantage of the present invention is to provide a flashlight assembly and a method for using the same wherein the flashlight assembly may have a battery to power the light source wherein the battery may be in a light assembly.

Another advantage of the present invention is to provide a flashlight assembly and a method for using the same wherein the flashlight assembly may have a battery to power the light source wherein the battery may be in the storage receptacle.

Still another advantage of the present invention is to provide a flashlight assembly and a method for using the same wherein the flashlight is compact and battery operated.

An advantage of the present invention is to provide a flashlight assembly and a method for using the same wherein the flashlight may be equipped with a plurality of different bulbs.

Another advantage of the present invention is to provide a flashlight assembly and a method for using the same wherein the flashlight may be equipped with a plurality of different bulbs wherein the bulbs may be of different colors.

Yet another advantage of the present invention is to provide a flashlight assembly and a method for using the same wherein the flashlight may have a light assembly which may be equipped with an attachment device to attach the light assembly to a storage receptacle.

An advantage of the present invention is to provide a flashlight assembly and a method for using the same wherein the flashlight assembly may include a storage receptacle that may be contained within a carrying case.

Still another advantage of the present invention is to provide a flashlight assembly and a method for using the same wherein the flashlight assembly may include a storage receptacle that may be contained within a carrying case and wherein the carrying case may be attached to the individual user.

Yet another advantage of the present invention is to provide a flashlight assembly and a method for using the same wherein the flashlight assembly may include a storage receptacle that may be contained within a carrying case and wherein the carrying case may include a plurality of attachment means for attachment to a desired object.

Still another advantage of the present invention is to provide a flashlight assembly and a method for using the same wherein the flashlight may have a light assembly wherein the light assembly may have a hold button thereon to keep the light source on when in use.

Yet another advantage of the present invention is to provide a flashlight assembly and a method for using the same wherein the light assembly may be stored in a carrying case when not in use.

Still another advantage of the present invention is to provide a flashlight assembly and a method for using the same wherein the flashlight may be utilized by a plurality of individuals.

Another advantage of the present invention is to provide a flashlight assembly and a method for using the same wherein the flashlight is simple to use.

An advantage of the present invention is to provide a flashlight assembly and a method for using the same wherein the flashlight may be constructed of metal.

Yet another advantage of the present invention is to provide a flashlight assembly and a method for using the same wherein the flashlight may be constructed of plastic.

Still another advantage of the present invention is to provide a flashlight assembly and a method for using the same wherein the flashlight may be constructed of any rigid material.

Still another advantage of the present invention is to provide a flashlight assembly and a method for using the same wherein the wiring of the flashlight assembly may be flexible.

Another advantage of the present invention is to provide a flashlight assembly and a method for using the same wherein the wiring of the flashlight assembly may be manipulated as to direct the light assembly at a desired object.

These and other objects of the invention will become more clear when one reads the following specification, taken together with the drawings that are attached hereto. The scope of protection sought by the inventors may be gleaned from a fair reading of the claims that conclude this specification.

Additional features and advantages of the present invention are described in, and will be apparent from, the detailed description of the presently preferred embodiments and from the drawings.

### DESCRIPTION OF THE DRAWINGS

FIG. 1 is a perspective view of the flashlight assembly in an embodiment of the present invention;

FIG. 2 is a perspective view of the flashlight assembly in another embodiment of the present invention;

FIG. 3 is another perspective view the flashlight assembly showing the back of the light assembly in an embodiment of the present invention;

FIG. 4 is another perspective view of the flashlight assembly illustrating the interior of the attachment means in an embodiment of the present invention;

FIG. 5 is front view of the interior of the light assembly in an embodiment of the present invention;

FIG. 6 is another perspective view of the flashlight assembly illustrating the interior of the attachment means in an embodiment of the present invention;

FIG. 7 is a top view of the flashlight assembly illustrating the wiring stretched away from the storage receptacle in an embodiment of the present invention;

### DESCRIPTION OF THE PREFERRED EMBODIMENT

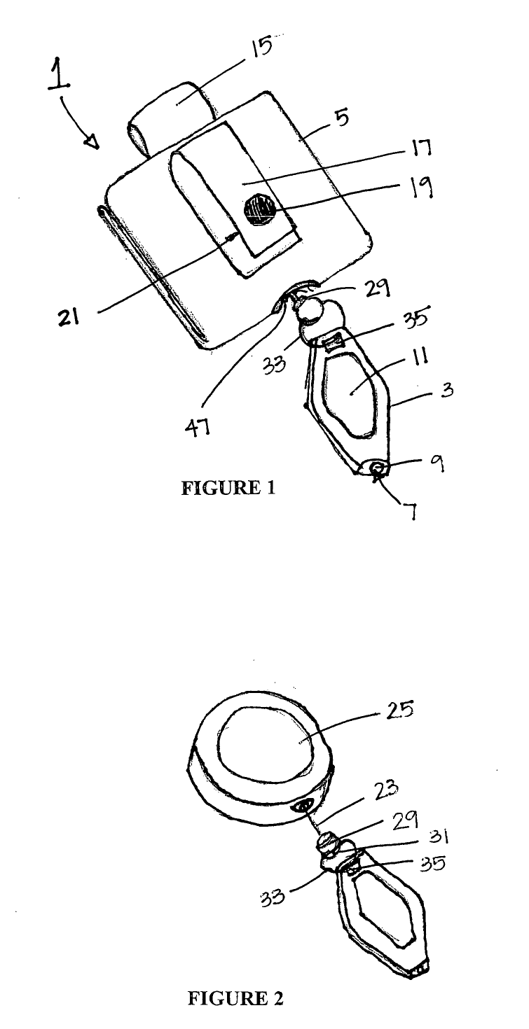

Turning now to the drawings wherein elements are identified by numbers and like elements are identified by like numbers throughout the 7 figures, the invention is depicted in FIG. 1 that shows a flashlight system 1 for illuminating an object by a user (not shown).

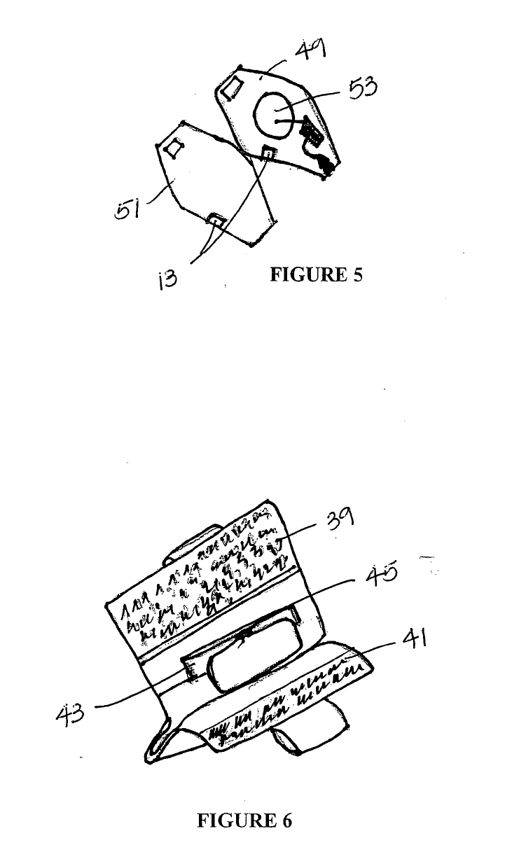

As shown in FIG. 1, the flashlight assembly 1 may be comprised of several different components. The flashlight assembly may have a light assembly 3 that may be attached to an attachment means 5. The light assembly 3 may have a light source 7. In a preferred embodiment, the light source 7 may be a bulb 9. The bulb 9 may be of any color and of any intensity to illuminate a desired object (not shown). In a preferred embodiment, the light bulb 9 may be a high intensity bulb that may illuminate an object and/or objects a great distance away from the flashlight assembly 1. The bulb 9 may be secured within a lighting assembly 3. The lighting assembly 3 may also have thereon a button 11. The button 11 may be depressed to commence the illumination of a desired object (not shown). The button 11 may be held by an individual (not shown) to allow for continued illumination. However, in another embodiment, the button 11 may only need to be pressed once to keep the light illuminated until the user desires to shut off the illumination. In another embodiment, the light source 3 may be illuminated without a button 11. As illustrated in FIG. 5, a sensor 13 may be placed within the lighting assembly 3 that may sense when insufficient light is available, and the lighting assembly 3 may automatically turn on when insufficient light is available.

FIG. 1 also illustrates an attachment means 5. The attachment means 5 may facilitate the transport of the flashlight assembly 1. The attachment means 5 may be connected to the body and or the clothing of an individual for transport of the flashlight. The attachment means 5 may have a loop 15 that may fit onto the belt of an individual. The loop 15 may also fit onto a number of different applications, such as backpacks, hipsacks and others. Moreover, the attachment means 5 may also have a front clip 17 that may clip onto apparel or other apparatuses. The front clip 17 would have a male end 19 to be received by a female end 21. After attachment to a desired piece, the male end 19 could be attached to the female end 21 to secure the flashlight assembly 1 to the desired piece. In another embodiment, the front clip 17 could be a hook and fastener. The hook could fasten to any fastener to secure the flashlight assembly to a desired apparatus and/or apparel.

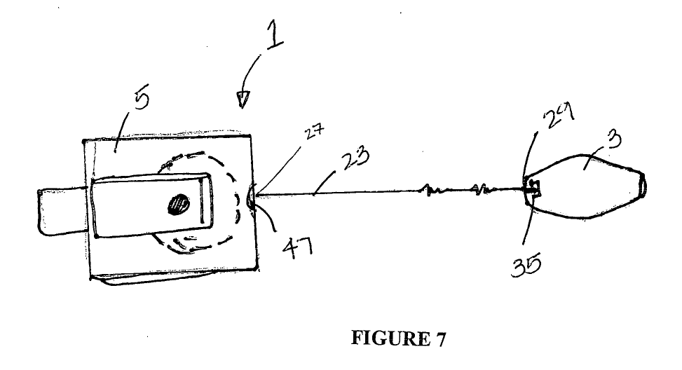

In an embodiment of the present invention, the lighting assembly 1 may be secured to the attachment means 5 by a wire 23 as illustrated in FIG. 7. The wire 23 may attach the lighting assembly 3 to the attachment means 5. In the preferred embodiment of the present invention, the wire 23 may attach the lighting assembly 3 to a storage receptacle 25. The storage receptacle 25 may store the desired length of wire 23 when not in use. The storage receptacle 25 as illustrated in FIG. 2 may be of cylindrical shape. However, any shape of storage receptacle 21 may be utilized. The storage receptacle 25 may contain one end of the wire 27 and allow said wire 23 to extend outwardly away from the receptacle 25. The second end 29 of the wire 23 may be secured to the lighting assembly 3 such that the lighting assembly 3 may extend outwardly away from the storage receptacle 25 when needed.

FIG. 2 illustrates a perspective view of the storage receptacle 25 showing the wire 23 extending away therefrom and attaching to the lighting assembly 3. In an embodiment, the lighting assembly 3 may be detached from the wire 23 for use further away than the wire 23 will allow the lighting assembly 3 to extend. The lighting assembly 3 may be attached and/or detached from the wire 23 using an securing means 31. The securing means 31 may be positioned on any means of detaching and attaching the lighting assembly 3 to the wiring 23. In a preferred embodiment, the securing means 31 may be a ring 33. The lighting assembly 3 may have an opening 35 therethrough to allow for attaching the lighting assembly 3 and/or detaching the lighting assembly 3 to the wire 23. The wire 23 may span a distance away from the storage receptacle 25. In an embodiment, the distance may be predetermined.

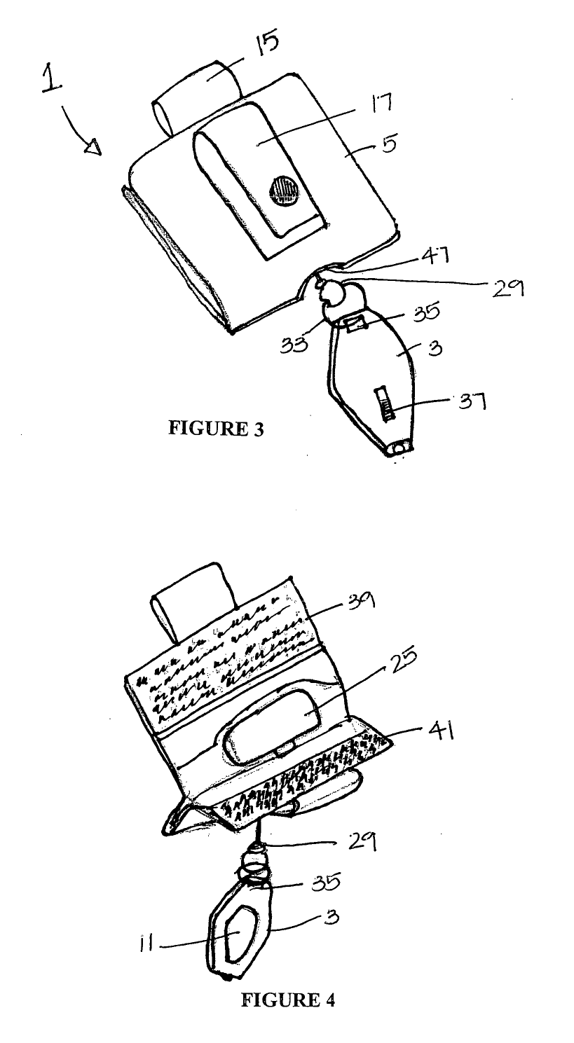

FIG. 3 illustrates a perspective view of the attachment means 5 and the lighting assembly 3. The lighting assembly 3 may have a hold button 37 on the back thereof. The hold button 37 may allow the user to press the button 37 on the front of the lighting assembly 3, engage the button 37 such that the user does not need to keep holding the button 37 but rather just move the lighting assembly 3 in the direction illumination is desired.

FIG. 4 illustrates the attachment means 5 when opened. As illustrated the storage receptacle 25 may be placed inside the attachment means 5 for attachment to a desired object. The attachment means 5 may have a first side 39 and a second side 41. The first side 39 may be detachable from the second side 41 using a hook and fastener means. Any other fastener means may be used to secure first side 39 to said second side 41. The storage receptacle 25 may be inserted into the space between the first side 39 and the second side 41 of the attachment means 5. As FIG. 6 illustrates, a pocket 43 may be contained on either the first side 39 and/or the second side 41. The pocket 43 may secure the storage receptacle 25 therein. In another embodiment, the pocket 43 may store additional batteries (not shown) to be used in the lighting assembly 3. Moreover, in another embodiment, the pocket 43 may be used to secure a clip 45 on the storage receptacle 25 such that the storage receptacle 25 may be secured to the attachment means 5. The bottom of the attachment means 5 may have an opening 47 therethrough for the wire 23 to extend outwardly away from the attachment means 5 (see FIG. 1, FIG. 3). The attachment means 5 may be opened to remove the storage receptacle 25 from the attachment means 5 when desired by an individual (not shown).

FIG. 5 illustrates the lighting assembly 3. The lighting assembly 3 may have a first side 49 and a second side 51. FIG. 5 illustrates the first side 49 disjoined from the second side 51 to show the inside of the lighting assembly 3. In a preferred embodiment, the lighting assembly 3 may have a power supply 53 contained therein to power the light source 9. In a preferred embodiment, the power source may be a battery 53. In another embodiment of the invention, the power source 53 may be contained within the storage receptacle 25 or in the attachment means 5. The lighting assembly 3 may also have a light sensor 13 to detect if sufficient light is available in a certain location. If the sensor 13 detects inadequate light, the sensor 13 could activate the lighting assembly 3 to automatically illuminate.

It should be understood that various changes and modifications to the presently preferred embodiments described herein will be apparent to those skilled in the art. Such changes and modifications may be made without departing from the spirit and scope of the present invention and without diminishing its attendant advantages.

1. A retractable flashlight assembly for use in conjunction with a lighting assembly, the flashlight assembly comprising:
a lighting assembly having a light source contained thereon;
a spring-biased wire assembly mounted within a storage receptacle for extracting and retracting said lighting assembly;
a storage receptacle to house the spring-biased wire assembly when wire assembly is retracted wherein a user can extract the lighting assembly from a position adjacent the storage receptacle to illuminate an object and thereafter retract the lighting assembly to a position adjacent the storage receptacle; and
an attachment means whereby the flashlight assembly is securable about an object.

2. The flashlight assembly of claim 1 further comprising:
said lighting assembly having a light source wherein said light source is a bulb and further wherein said lighting assembly has a button contained thereon to turn on and turn off said light source.

3. The flashlight assembly of claim 1 further comprising:
said lighting assembly has a power source contained thereon to power the light source.

4. The flashlight assembly of claim 1 further comprising:
said light assembly detachably secured to the wire assembly and further wherein said light source is activated by a light sensor.

5. The flashlight assembly of claim 1 further comprising:
said spring biased wire assembly being detachably secured to the lighting assembly at a first end and being secured to the storage receptacle at a second end.

6. The flashlight assembly of claim 1 further comprising:
said storage receptacle having a means for attaching to an article.

7. The flashlight assembly of claim 1 further comprising:
the attachment means whereby the flashlight assembly is securable about an object wherein the attachment means has a fastening clip.

8. The flashlight assembly of claim 1 further comprising:
the attachment means whereby the flashlight assembly is securable about an object wherein the attachment means has loop contained thereon.

9. The flashlight assembly of claim 1 further comprising:
the attachment means whereby the storage receptacle may be inserted into the attachment means whereby the storage receptacle may be secured to the attachment means wherein the attachment means secures the lighting assembly, storage receptacle and wire assembly to an object.

10. The flashlight assembly of claim 1 further comprising:
the attachment means whereby the attachment means has a pocket contained thereon to store accessories.

11. The flashlight assembly of claim 1 further comprising:
the attachment means whereby the attachment means has an opening contained thereon wherein a wire from said wire assembly may extend outwardly away from said attachment means when said attachment means is secured to an object.

12. The flashlight assembly of claim 1 further comprising:
the attachment means whereby the attachment means has a fixed opening contained on the bottom thereof and further wherein the attachment means has a resealable opening on the top thereof wherein said resealable opening uses a hook and loop fastener and wherein said resealable opening allows for insertion of said storage receptacles or accessories into said attachment means.

13. A method for using a flashlight assembly, the method comprising the steps of:
providing a lighting assembly having a light source contained thereon;
providing a spring-biased wire assembly mounted within a storage receptacle wherein said wire assembly has a first side and a second side wherein said first side is detachably connected to the lighting assembly and further wherein said second side is connected to a storage receptacle;
providing a storage receptacle to house the spring-biased wire assembly; and
providing an attachment means whereby the flashlight assembly is securable about an object wherein said attachment means may be opened to contain the storage receptacle and further wherein said attachment means has a fixed opening wherein said wire assembly may extend out of said fixed opening.

14. The method as described in claim 13 further comprising the step of:
securing the attachment means to a object wherein the attachment means may use a hook and loop fastener, a clip assembly, a zipper and/or loop to attach to an object.

15. The method as described in claim 13 further comprising the step of:
grasping the lighting assembly from a position adjacent the attachment means and extending said lighting assembly away from said attachment means by use of the wire assembly wherein the wire assembly extends outwardly away from said storage receptacle.

16. The method as described in claim 13 further comprising the step of:
depressing a button contained on the lighting assembly to activate the light source.

17. The method as described in claim 13 further comprising the step of:
moving the lighting assembly to illuminate a desired object wherein the wire allows for maneuverability of the lighting assembly away from the attachment means.

18. The method as described in claim 13 further comprising the step of:
depressing a button on the lighting assembly to de-activate the light source.

19. The method as described in claim 13 further comprising the step of:
allowing the spring biased wire to detract into the storage receptacle wherein the lighting assembly is retracted therewith such that the lighting assembly becomes adjacent to the attachment means.

20. The method as described in claim 13 further comprising the step of:
releasing the lighting assembly and allowing said attachment means to carry said flashlight assembly when not in use.
